(19) United States
(12) Patent Application Publication
(10) Pub. No.: US 2008/0129964 A1
(43) Pub. Date: Jun. 5, 2008

(54) Beam shaping component and method

(75) Inventor: Ilkka A. Alasaarela, Liminka (FI)

Correspondence Address: HARRINGTON & SMITH, PC, 4 RESEARCH DRIVE, SHELTON, CT, 06484-6212, US

(73) Assignee: Upstream Engineering Oy

(21) Appl. No.: 11/998,784

(22) Filed: Nov. 30, 2007

Related U.S. Application Data
(60) Provisional application No. 60/861,793, filed on Nov. 30, 2006.

(51) Int. Cl. G03B 21/14; F21V 5/02

(52) U.S. Cl. 353/81; 362/311; 353/121

(57) ABSTRACT

An optical device includes a source such as an LED, a microdisplay such as an LCoS panel, and a relay prism between them. The relay prism has input and output surfaces arranged to tilt the system optical axis. At least one of those surfaces is a cylindrical surface that, along with the tilt, changes the aspect ratio AR of light emanating from the source to the AR of the microdisplay without clipping. The cylindrical surface defines parallel cross sections, each of which define a center of curvature that together define a line that crosses the system optical axis or an extension thereof. This preserves total luminance since clipping is not used to change the AR, and provides substantially uniform illumination across the new AR. Also detailed is a method and further details of an exemplary pocket sized optical engine for which the output of the microdisplay is directed to a projection lens.

### CROSS REFERENCE TO RELATED APPLICATIONS

This application claims priority to U.S. Provisional Application Ser. No. 60/861,793, filed on Nov. 30, 2006 and entitled “Beam Shaping Component and Method”, the contents of which are incorporated by reference herein in its entirety. These teachings are also related to co-owned U.S. Provisional Application Ser. No. 60/872,051 (filed on Nov. 30, 2006), U.S. patent application Ser. No. 11/891,362 (filed on Aug. 10, 2007), and issued U.S. Pat. Nos. 7,059,728 and 7,270,428, the contents of which are all incorporated by reference herein in their entirety.

### TECHNICAL FIELD

This invention generally relates to data projectors, specifically to light emitting diode (LED) illuminated data projectors.

### BACKGROUND

In past years advances in high-brightness light emitting diodes (LEDs) have opened the way to new kinds of applications. LEDs have become used as flashes in cellular phones and in other digital cameras, as back lighting in large liquid crystal display LCD screens, and as light sources in rear projection television RPTV displays. One of the new applications these LEDs will enable is a very small mobile data projector, such as a handheld one that will fit nicely in one's pocket. LEDs have several desirable properties for that application, such as small size, cheap price, instant-on feature, colour richness, safety, and by recent advances their brightness too. These kinds of projectors are not yet on the market though many companies have presented their desire to use them in consumer products. One challenge for getting that kind of application to the market is to design and build the optical engine so well that the brightness and image quality of the projector would satisfy the anticipated market demand. Still new innovations are needed for utilizing the properties of the LED chip as well as possible for achieving the desired performance.

So one of the key problems that these teachings address is to achieve sufficient performance from the above mentioned LED-based real pocket projectors, i.e. good brightness and uniformity, low power consumption, small size and small prize.

High brightness LED chips typically are rectangular in their geometry. LED chips emit light to substantially a hemisphere. The light needs to be collected from that hemisphere and shaped to form a rectangular beam to the micro-display. Micro-displays are for example liquid crystal devices (LCD), liquid crystal on silicon devices (LCoS) or digital micro-mirror devices (DMD). Relevant teachings in this regard may be seen as co-owned U.S. Pat. Nos. 7,059,728 and 7,270,428, referenced above.

In larger conventional projectors, which typically use an arc-lamp as a light source, the collection and beam shaping is typically done by using an elliptical mirror together with a lens-lightpipe-lens system or a fly's eye lens array. The elliptical reflector collects the light and the lightpipe or the fly's eye lens array shapes the beam to match with the rectangular micro-display. Elliptical reflectors are not seen as viable for use with high brightness LEDs, because LEDs demand mounting to a substrate, which in its part needs to be integrated with a heat sink. Alternatives for the elliptical reflectors for light collection from LED chips are for example lenses, total-internal-reflection (TIR) collimators or truncated parabolic reflectors. These components collect light but do not shape the beam well enough to match the micro-display shape. These components can be used together with the lightpipe or the fly's eye lens array in order to get rectangular illumination of a desired aspect ratio.

One important issue in LED projector design is the etendue law, also detailed in the above referenced US patents. Brightness of the high brightness LEDs is still quite weak for projection applications in the prior art. Therefore, optical systems need to use as large a chip as possible to illuminate the micro-display in the limits of the etendue law. On the other hand, the micro-display needs to be small (below 0.8″ and preferably below 0.55″ diagonal) in order to have the projector attain a sufficiently small size (handheld or even pocket size). In order to have highest possible brightness, the etendue of the LED chip should be equal to the etendue of the micro-display. In that case, the optical engine disposed prior to the microdisplay should not increase the system etendue, in order to be able to couple as much light as possible from the LED chip to the micro-display.

Now, in the view of the etendue law, a drawback of using a lightpipe or fly's eye lens array is that the etendue of the optical system is increased prior to the micro-display, which will result either in an increase in the size of the projector, or a loss of brightness. Although etendue is preserved in the lightpipe and fly's eye lens components themselves, the system etendue is increased following these components.

Another way to shape the beam to the desired rectangular form is to benefit from the fact that the LED chip has a rectangular geometry. A typical high-brightness LED chip is thin and square-shaped, with dimensions of 1 mm×1 mm×0.1 mm for example. There are two kinds of LED chips available: ones in which the chip is encapsulated with an optically transparent material, and ones without such encapsulation. The non-encapsulated chips can be imaged by using a pair of lenses to form a rectangular illumination to a micro-display. Encapsulated chips can be “imaged” by using for example components described in the above-referenced co-owned U.S. patent application Ser. No. 11/891,362 entitled “Illuminator Method and Device”.

One drawback of these approaches is that if the LED chip is square, also the illumination is square. Because cylindrically symmetric beam shaping optics is used, the shape of the illumination will resemble the shape of the source even at its best. The better the etendue and efficiency are preserved, the more the illumination has the shape of the LED chip. So, the drawback is that the aspect ratio of the rectangular illumination, i.e. the ratio of the width and the height of the rectangular illumination, is limited to be approximately the same as the aspect ratio of the source. When using a typical LED chip as a light source, which as above is dimensioned as 1 mm×1 mm×0.1 mm, the beam output would have aspect ratio of 1:1, i.e. square. However, the desired aspect ratios of the image on the micro-display (and on the resulting projected image) are typically different from that 1:1 (square) aspect ratio; such as 4:3 in most cases and 16:9 in another popular case just to mention two. That mismatch between the illumination and the micro-display aspect ratios results in only a portion of the beam being used for the illumination. For example if a 4:3 rectangular micro-display is illuminated with a beam with a 1:1 aspect ratio, approximately 25% of the light will be lost. Of course the situation is typically not this straightforward because the illuminating beam typically has edges and corners that are not well defined (not very sharp) but rather the beam resembles a rectangular aspect ratio instead of being precise rectangular. However, even though the geometries are not precise, the mismatch causes a loss of brightness and/or weakens the uniformity of the illumination.

One problem these teachings address is how to change the aspect ratio of a beam with rectangular illumination while sufficiently preserving brightness and/or uniformity of illumination.

### SUMMARY

In accordance with an embodiment of the invention there is a data projector that includes at least one micro-display, at least one light source chip, and at least one optically transparent relay prism disposed (optically) between the micro-display and the light source chip. The relay prism has an input surface and an output surface that together are arranged to impose a tilt to a system optical axis between the micro-display and the light source.

In accordance with an embodiment of the invention there is an apparatus that includes illumination means, display means and lens means. The lens means is disposed (optically) between the display means and the illumination means, and the lens means includes a first surface and a second surface that are arranged for imposing a tilt to a system optical axis between the illumination means and the display means. In a particular embodiment, the illumination means is a LED chip, the display means is a microdisplay, and the lens means is a relay prism having a cylindrical optical surface.

In accordance with an embodiment of the invention there is a method for manipulating light. In this method, light is emanated from a source to a relay lens along a first portion of a system optical axis, the emanated light is passed through the relay lens and output from the relay prism along a second portion of the system optical axis that is tilted with respect to the first portion. The light output from the relay prism is directed toward a micro-display.

### BRIEF DESCRIPTION OF THE DRAWINGS

These teachings are made more evident with reference to the drawings figures noted below. Further objects and advantages in addition to those noted above will become apparent from a consideration of the ensuing description and drawings.

FIG. 1 is a schematic diagram of an illumination system without the beam shaping teachings of this invention, made by using Zemax optical modelling software.

FIG. 2 is to scale, and is an intensity plot of (square) illumination at the microdisplay resulting from the system of FIG. 1 using a square LED source.

FIG. 3 is similar to FIG. 1 but with a relay prism disposed between the second collector lens and the micro-display according to an embodiment of the invention.

FIG. 4 is to scale, and is an intensity plot of (non-square) illumination at the microdisplay resulting from the system of FIG. 3 using a square LED source.

FIG. 5A-5D various views and sections of a relay prism according to an embodiment of the invention.

FIG. 6 is similar to FIG. 4 but for a relay prism similar to that shown in FIGS. 5A-5D having a planar output surface according to an embodiment of the invention.

FIG. 7 is similar to FIG. 4 but for a relay prism that does not tilt the system optical axis as in FIG. 3.

FIG. 8 is a schematic diagram of an optical system where an input surface of a relay prism that is designed to converge telecentric illumination input at that surface to a beam waist at the microdisplay according to an embodiment of the invention.

FIG. 9 is a schematic diagram of an optical projector system with a relay prism according to an embodiment of the invention and detailing behavior of the light beam at various cross sections of that system.

FIG. 10 is a schematic diagram of an optical engine of a LED-projector made with three channels, each channel having a LED chip, a beam shaping unit and a relay prism according to a specific embodiment of the invention.

FIGS. 11 and 12 are schematic diagrams of how embodiments of the relay prism might be made from multiple component parts as opposed to being formed from a single block of optical material.

### DETAILED DESCRIPTION

One purpose of the invention is to provide a component and method for modifying the aspect ratio of the illuminating beam to match with the micro-display shape, avoiding the loss of brightness and decreased uniformity. The described optical component is termed a “relay prism” in the following description.

Accordingly, several objects and advantages of embodiments of the invention are:
good efficiency
good uniformity
preserves etendue
slim form factor
cheap mass-manufacturing
versatility to convert between different aspect ratios
relay lens function integrated with the component
enables the use of polarization recycling.

The background section above detailed problems with a lightpipe-flys eye lens arrangement in that system etendue is increased. The inventor has determined that such an increase of the system etendue will not occur if the beam already exhibits a rectangular spatial distribution of the desired aspect ratio when entering into the lightpipe, or if the beam has already a rectangular angular distribution pattern of the desired aspect ratio when entering to the fly's eye lens array. However, if that would be the case, those components would not be needed at all, and we should have some other means to form the rectangular beam before these components. As such, embodiments of this invention provide an optical engine without a lightpipe and/or flys eye lens arrangement, though other embodiments do not exclude either of those components. Following are described some embodiments of the invention with reference to the figures.

### Prior Art Problem Illustrated

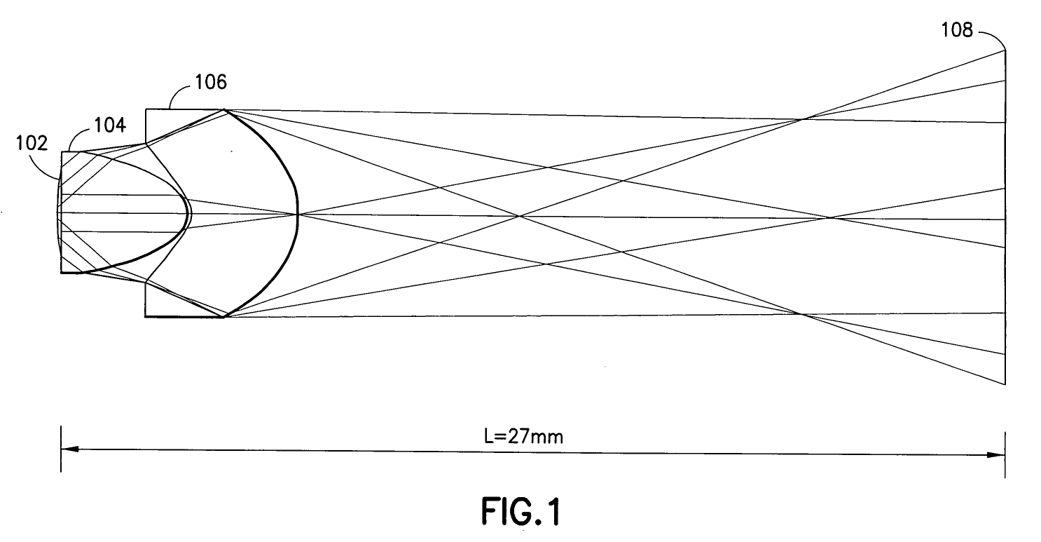

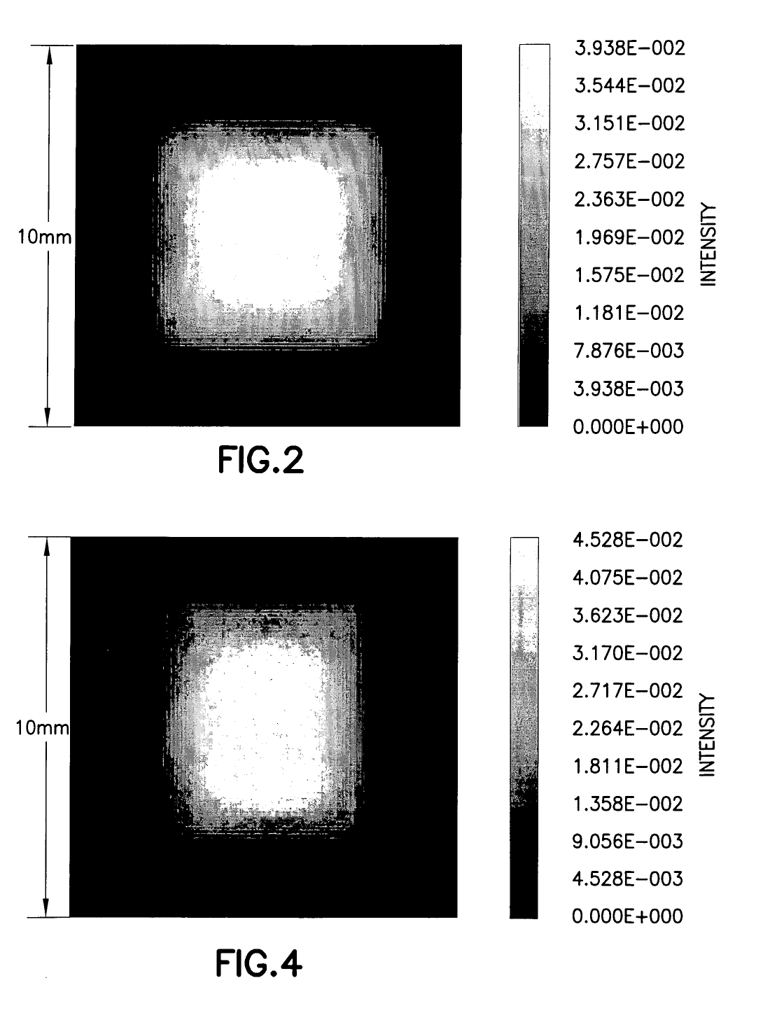

FIG. 1 shows an exemplary illumination system without the beam shaping method or apparatus of the invention. The figure is made by using Zemax optical modelling software (by ZEMAX Development Corporation, Bellevue, Wash., USA), which is a feasible tool for modelling many kinds of optical systems. The light source (102) shown is a thin square shaped LED chip. Two lenses (104, 106) collect the light and form a smoothed image (108) of the LED chip at distance L from the LED chip. FIG. 2 is to scale and shows the illumination at distance L. As seen in FIG. 2, a square shaped LED chip forms a square shaped illumination. 96% of the light emitted from the LED chip is illuminating the square. Even though the edges are not perfectly sharp and the illumination is dimmer near the edges, that edge illumination could be used to illuminate a square shaped micro-display for example. However, the problem is that if the micro-display 108 has a 4:3 aspect ratio, approximately 25% of the light would be lost. The 4:3 aspect ratio would have to be clipped from the existing square illumination shown, resulting in the illumination that is outside that 4:3 rectangle but within the square illumination shown in FIG. 2 to be lost.

### Problem Solved by a Relay Prism Component

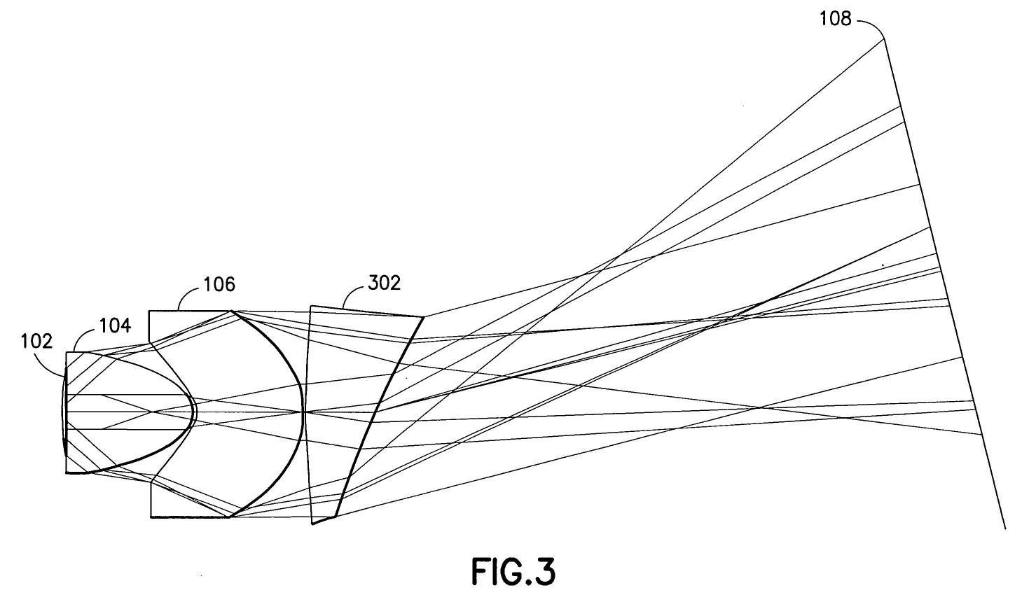

FIG. 3 shows how the above mentioned problem can be solved by using a relay prism component according to these teachings. The relay prism (302) is disposed between the second collection lens 106 and the microdisplay 108, and positioned just after the second collection lens (106). The relay prism component 302 tilts the beam and at the same time, shapes the beam to a 4:3 aspect ratio as shown in FIG. 4. FIGS. 2 and 4 are to scale. The illumination efficiency is 94% at FIG. 4 and so the 25% loss of light noted above with respect to FIG. 2 is avoided. The optical axis of the system of FIG. 3 is along the centerline of the ray traces. As can be seen, the relay prism changes the path of the optical axis so that the microdisplay 108 is offset from that portion of the optical axis defined by the collecting lenses 1-4, 1-6 and light source 102 (e.g., the hOorizontal centerline of those components as depicted).

### Description of the Relay Prism

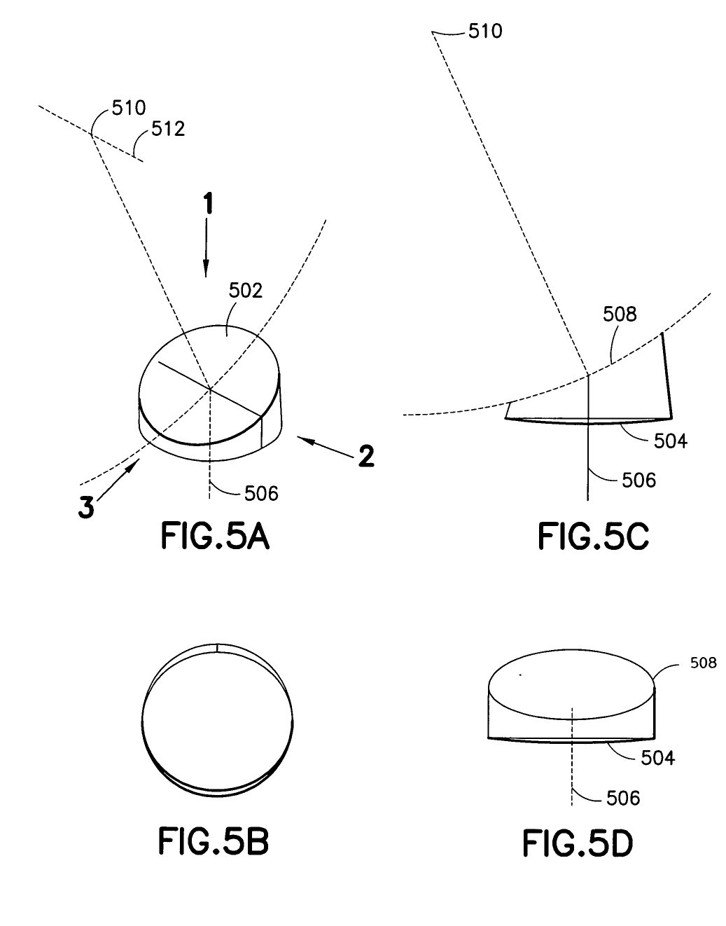

FIGS. 5A-5D show an exemplary embodiment of the relay prism 502. FIG. 5A shows a 3D-view of the component. FIG. 5B shows view from the top of the component, as shown by the arrow with number 1 in FIG. 5A. FIGS. 5C and 5D show views from the front and right sides of the component respectively as shown by the arrows with numbers 2 and 3 in FIG. 5A. The relay prism 502 is made of a solid block of material which is optically transparent in the desired wavelength range. The input surface (504, disposed to face the light source/LED) works as a lens surface whose center of curvature is located at the same line with the optical axis (506) from the LED chip to the first surface 504 of the relay prism 502. The output surface (508, disposed to face the target/microdisplay) of the relay prism 502 is cylindrical in its shape (detailed below), and its center of curvature 512 is located offset from the optical axis. The input surface 504 works as a relay lens converging or diverging the beam in order to form the beam waist to the desired distance. The output surface 508 tilts the beam and the optical axis in a manner that changes the aspect ratio of the illumination (as compared to the aspect ratio at the input surface). The aspect ratio of the illumination changes the more the center of curvature of the cylindrical surface 508 is moved off-axis from that portion of the optical axis shown as 506. The purpose of the cylindrical shape at the output surface is to correct the spreading of the beam which can happen especially when the tilt angle between input 506 and output 508 surfaces is large. One of the input and output surfaces can be made flat, with the beam-waist converging/diverging and the illumination uniformity functions being combined into the curvature of the remaining non-planar input or output surface.

The arcuate surface of the relay prism is termed a cylindrical surface (the output surface 508 as shown), and may be conceptualized in its simplest form as a planar surface with a curvature imposed along a single dimension. The term cylindrical surface is used to denote that the surface is like a portion of a cylinder's arcuate surface, whether the cylinder has a circular or ellipsoidal cross section. Unlike traditional focusing lenses, there is no single point defining the center of curvature for a cylindrical surface; each parallel cross section of that cylindrical surface defines a point at the cross section's center of curvature, and the points from those various cross sections form a single line. FIG. 5C shows one such cross section, with the center of curvature 510 shown as offset from the optical axis 506. The line defined by several such center of curvature points is shown as a dashed line 512 at the perspective view of FIG. 5A. For the views of FIGS. 5B and 5D, the line runs horizontal across the drawing page; for the view of FIG. 5C, the line lies perpendicular to the drawing page and runs through point 510. It is noted that the line formed by the centers of curvature need not cross that portion of the system optical axis that lies physically between the source and the display surface of the microdisplay, but may in fact cross the optical axis as extended beyond the physical bounds of those components. This will most likely be the case for embodiments that are pocket sized projectors. This will most likely be the case for embodiments that are pocket sized projectors. Note that the net effect of the cylindrical surface is to elongate (or shrink, depending on which direction the light travels) the aspect ratio in only one direction. Where the plane of the microdisplay active area is considered the x-y plane, the cylindrical surface operates to magnify light from the source in one of the x and y directions more than it magnifies the light in the other of the x and y directions.

Further complexity may be added by imposing several cylindrical curvatures along a single surface, such that the lines defined by the cross sectional center of curvatures of the different cylindrical curvatures does not intersect across the surface. Preferably, such lines would be parallel. Whereas FIGS. 5A-D shows a relay prism 502 in which its cross section perpendicular to the optical axis (the view of FIG. 5B) is circular, the same concept can be extended to prisms/lenses with such cross sections that are non-circular. For example, such cross sections could be non-circular elliptical, square or rectangular.

### Designing an Relay Prism

By applying this innovative idea of the relay prism component as described here, an experienced optical designer can find suitable geometry for the relay prism for solving his specific illumination problem by using one of the sophisticated optical modelling tools such as Zemax, Oslo, Code V etc. The radius of curvature of the input surface 504 and the output surface 508 can be varied: they can be convex or concave depending on the specific optical system needs. The radius of curvature can be even infinity for one of them. Also, the center of curvature of the input surface 504 can be laid off-axis in some cases, if needed. The input 504 and the output 508 surfaces can be aspheric as well. The cylindrical output surface 508 can also be biconic surface with different radius of curvatures in different directions. The relay prism component 502 can also be disposed in reverse of the way illustrated and described above, i.e. the beam from the source can come from the output surface 508 and exit from the input surface 504. That would be the case for example when changing from a more elongated 16:9 aspect ratio to a flatter 4:3 aspect ratio.

### Purpose of the Cylindrical Shape and the Tilt of the Output Surface

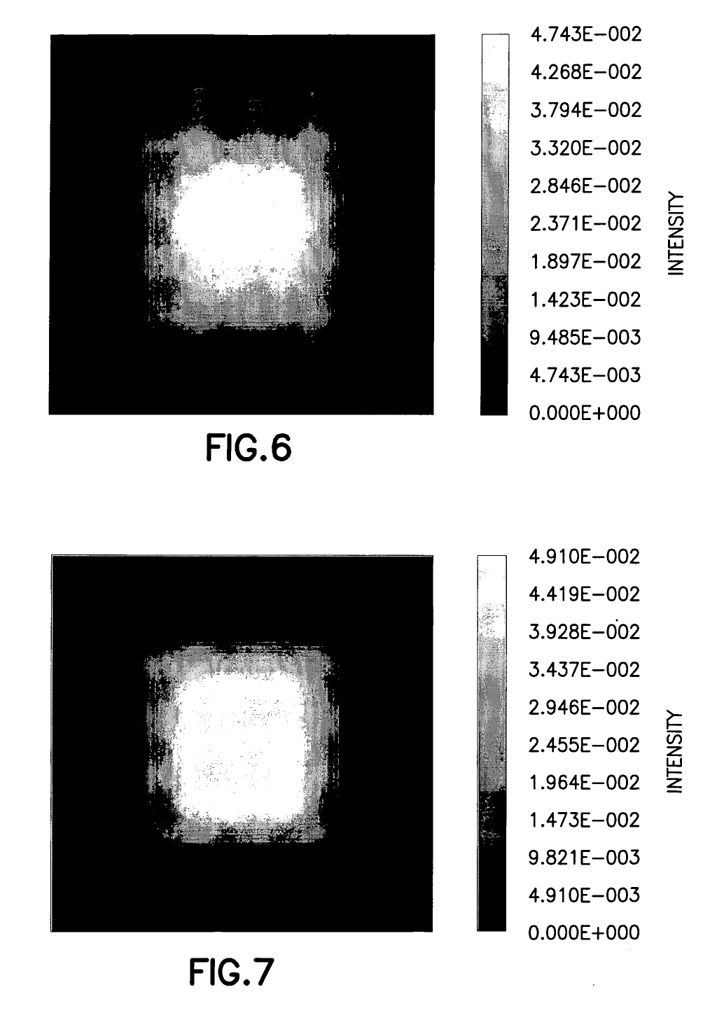

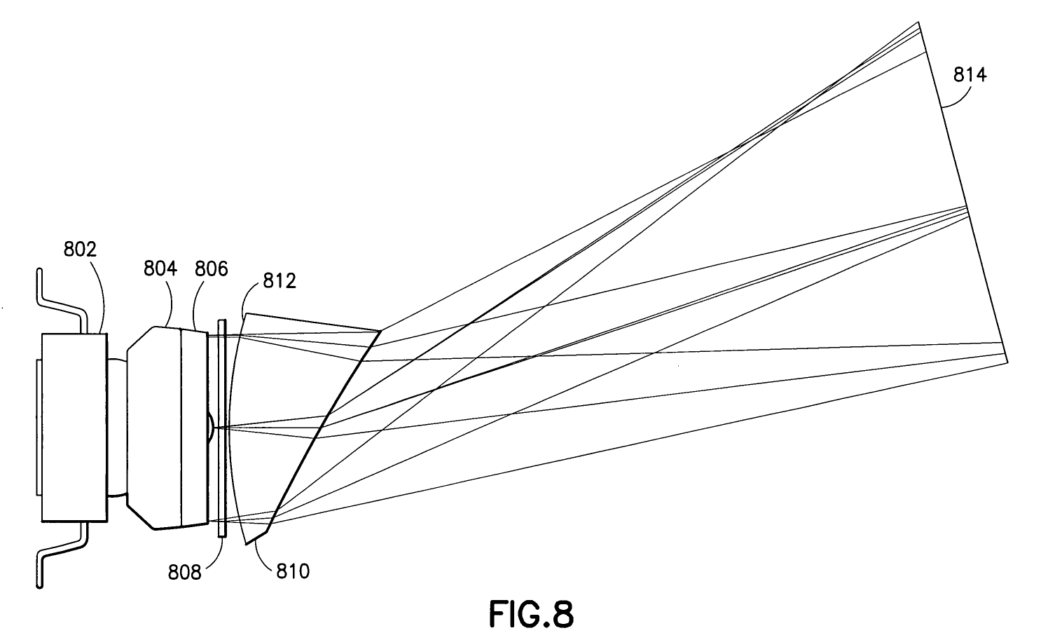

FIGS. 6 and 7 are to scale. FIG. 6 shows the illumination of the configuration shown in FIG. 3 when the output surface has infinite radius of curvature (i.e. it is planar). In comparison to the illumination shown in FIG. 4, the beam now has a severe non-uniformity problem. On the other hand, if we keep the cylindrical shape of the output surfaces as shown in FIG. 3, but place the center of the curvature of the cylindrical output surface on the optical axis (e.g., the line defined by the centers of curvature of the various parallel cross sections, but without the tilt imposed on the system optical axis as shown in FIG. 3), we will get the illumination shown in FIG. 7. The beam is uniform, but does not have 4:3 aspect ratio; it has the same aspect ratio (square) as that of the source LED chip. Thus the combination of cylindrical surface shape and tilt to the system optical axis imposed by the relay prism cause the desired aspect ratio change.

### Spherical Shape of the First Surface

The output surface 508 of the relay prism 502 modifies only one dimension of the beam. Certain embodiments integrate the lens shape to the input surface 504 of the relay prism 502, which allows one to adjust the position of the beam waist. Therefore by the first surface 504 we can also scale the illuminated area size by changing the beam waist position. In FIG. 1 we can see that the illuminated area size is 5.7 mm×5.7 mm and distance from the LED chip is L=27 mm. In FIG. 3 is shown the same beam shaping components plus the relay prism. The convex lens surface 504 of the relay prism 502 adjusts the size of the illuminated beam to be 4.7 mm×6.2 mm at the distance 25 mm from the LED chip along the optical axis.

Another example is shown in FIG. 8. A LED package (802) is integrated with a beam shaping component (804) as shown in U.S. patent application Ser. No. 11/891,362, noted above. The beam is circular in its spatial distribution at the beam shaping component output (806). The cones of light out of the circular area are square shaped cones directed perpendicular out from the circular output plane. In other words, the illumination is telecentric, which allows placing a polarization recycling component (808) after the beam shaping component output. A polarization recycling component is for example such as described in conference paper (Willemsen et al. SID 2005), consisting a quarter wave plate and a reflective polarizing foil. Now, the relay prism (810) inserted above the polarization recycling component 808, clearly includes a convex input surface (812). That input surface 812 functions to converge the cones of light to overlap and form a rectangular illumination on the micro-display (814). As these examples show, by adjusting the curvature of the input surface 812 of the relay prism 810, convergence of the beam can be adjusted so that the beam forms its waist at the micro-display.

### Beam Guiding Through an Engine

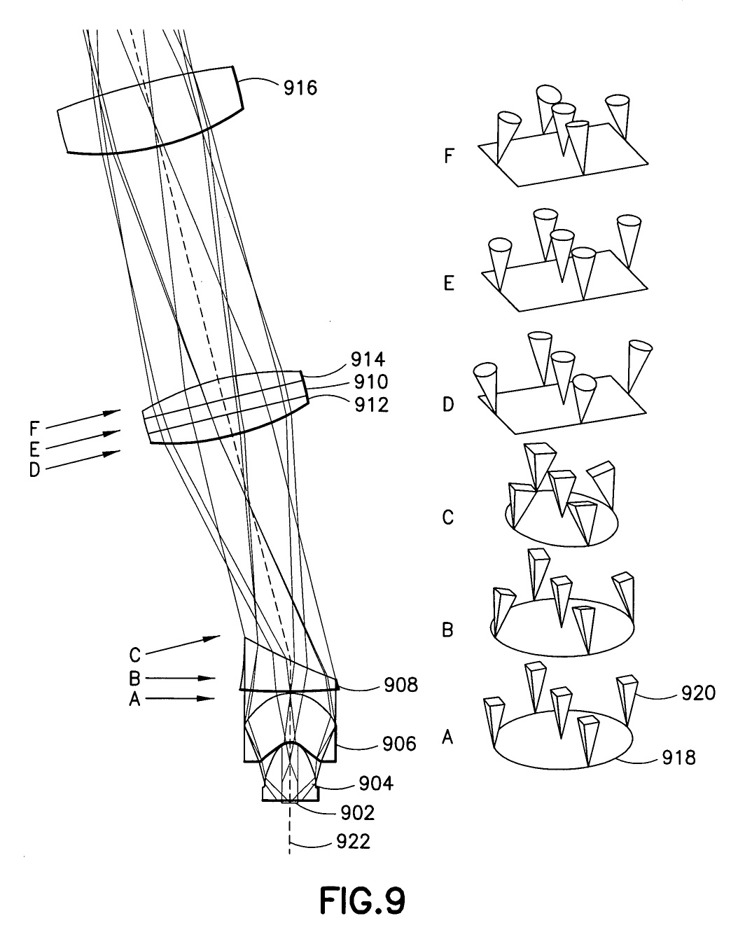

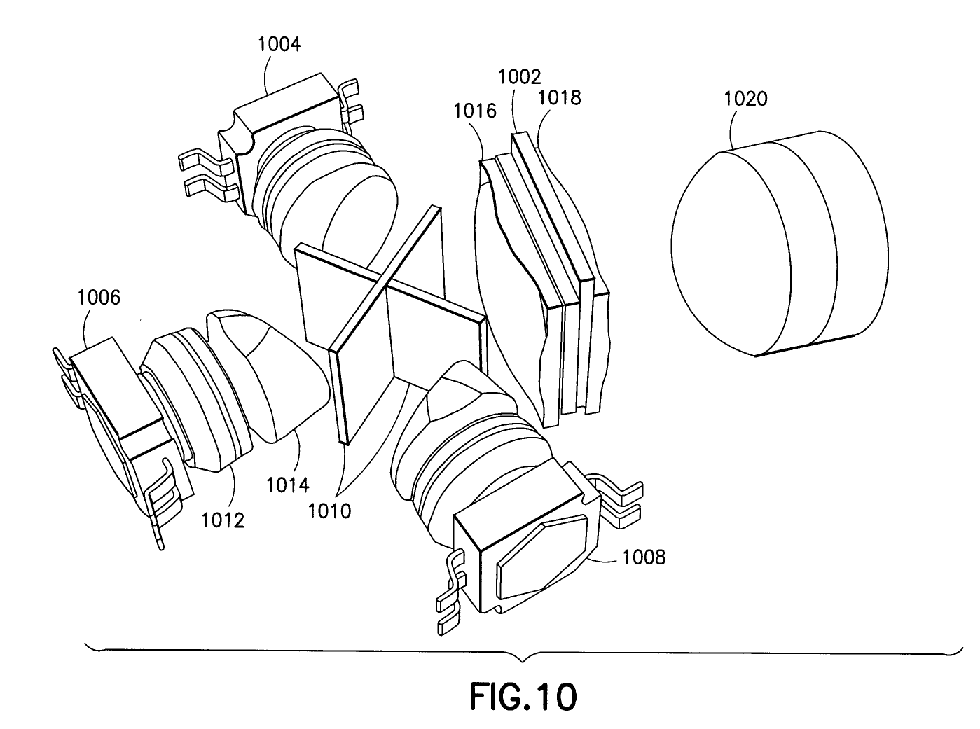

FIG. 9 explains how the illumination beam can be guided through a LED projector when a relay prism is used. FIG. 9 shows an optical engine schematically, which consists of a LED chip (902), beam shaping lenses (904, 906), relay prism (908), LCD panel (910) and lenses (912, 914) before and after the panel 910, and a projection lens (916). The LED chip 902 emits light to substantially the whole hemisphere of the first lens 904. The light beam is collected and substantially collimated by using a beam shaping unit consisting of the two lenses 904, 906.

After the beam shaping lenses (904, 906) the beam has circular spatial distribution (918) (i.e. illuminated area) as shown at inset A. The angular distributions (i.e. the angles where light is going) are substantially similar in every position of the beam, and are square shaped cones as drawn in inset A (920), which shows schematically the spatial and angular distribution of the beam at cross section position A of FIG. 9. As we can see, the illumination at this position is telecentric, and so, this position is a good place for a polarization recycling sheet if desired.

Inset B shows the beam at the cross-section B of FIG. 9, which is through the relay prism after the beam has passed the input surface of the relay prism. The input surface acts as a convex lens, which converges the square shaped light cones towards the optical axis (922) (shown by the dashed line in FIG. 9). The purpose of this convergence is that the square cones from the different positions of the beam at cross section B need to coincide at the micro-display 910. As we can see, the beam at this phase has still substantially square shaped angular distribution which is shaped to 4:3 aspect ratio by the output surface of the relay prism 908 at cross section C.

The cross section C is shown at inset C of FIG. 9. The spatial distribution has now an elliptical shape, and the angular distribution has a rectangular shape with 4:3 aspect ratio. Beams are still converging towards the micro-display 910. The output surface of the relay prism 908 tilts the optical axis 922 and preserves uniformity of illumination over the ellipsoid spatial distribution. The spatial distribution of the bended beam is the projection of the circular beam to the new direction, i.e. the circle shrinks in the other dimension and becomes an ellipse. Due to the etendue law, the angular extent of the beam now increases by the same ratio and in the same dimension where the spatial extent decreased. As a result, the decreased illuminated area (the ellipsoid spatial distribution) has increased the angular width of the beam by the same ratio, so the etendue of the beam is the same before and after the relay prism.

Inset D shows the cross section D of FIG. 9, which is taken just before the lens 912 before the LCD panel 910. Spatial distribution has become rectangular with the correct aspect ratio 4:3, and the angular distributions are now elliptical cones with the same 4:3 axis ratio. The cones are diverging, so the purpose of the lens before the panel is to turn the cones telecentric in order to maximize the contrast of the panel.

Inset E shows the cross section E of FIG. 9, i.e. at the LCD panel 910. The beam has the correct 4:3 rectangular shape with sharp edges, and the light cones are elliptical cones similar to at cross section D but now all directed forward in a telecentric way.

In miniature LED projectors it is important that the size of the projector is very small. The purpose of the field lens 914 after the panel 910 is to reduce the size of the projection lens. That field lens 914 converges the telecentric light cones from the panel towards the axis so that the projection lens 916 can be smaller than without the field lens 914. Inset F shows the beam cross section F of FIG. 9 just after the field lens 914.

### Three Channel LCD Engine

FIG. 10 shows a further example of an embodiment of the invention. The figure shows an optical engine of a LED-projector made with field-sequential LCD panel micro-display (1002). The panel is illuminated by using three LEDs: red (1004), green (1006) and blue (1008), forming three illumination channels. The beams from these channels are combined before the panel by using crossed dichroic mirrors (1010). Each channel contains a LED package containing an LED chip of one color, a beam shaping unit (1012) and a relay prism (1014) of the invention. The beam out of the beam shaping units 1012 is substantially telecentric, so that a polarization recycling component could be used between the beam shaping unit 1012 and the relay prism 1014 if desired. The first surface of the relay prism forms a lens surface which converges the telecentric beam to form a square shaped waist at the micro-display 1002. The second surface of the relay prism is a tilted cylindrical surface which shapes the beam to match the 4:3 aspect ratio of the micro-display 1002. There is a lens (1016) before the LCD panel 1002 which turns the illumination to telecentric before the panel in order to achieve maximum contrast. A field lens (1018) after the LCD panel 1002 turns the ray cones towards the entrance aperture of the projection lens (1020), which images the image from the panel to the projection screen.

### Conclusion, Ramifications, and Scope

Accordingly the reader will see that, according to embodiments of the invention is a method and apparatus for changing the aspect ratio of a rectangular beam by using a relay prism. While the above description contains many specifics in order to illustrate by example these teachings, these should not be construed as limitations on the scope of the invention, but as exemplifications of the presently preferred embodiments thereof. Many other ramifications and variations are possible within the teachings of the invention. For example by adjusting the parameters of the relay prism, it can be used to illuminate 16:9 or some other aspect ratio micro-display by using a rectangular source chip or chips. The source can be non-square, too. For example, if the LED chip has a 3:2 aspect ratio, one can use the relay prism to modify that aspect ratio to 4:3 or to 16:9. In addition, two or more LED chips can be used for example such that two square shaped LED chips are mounted next to each other to form a source with a 2:1 aspect ratio. Then a relay prism can fine tune the beam to match a micro-display with a 16:9 aspect ratio. The relay prism can also modify a beam which has been shaped rectangular already by using a lightpipe or fly's eye lens array, if desired in some applications. Generally speaking, the relay prism can be used in wide variety of applications where a rectangular aspect ratio illumination needs to be changed for some reason.

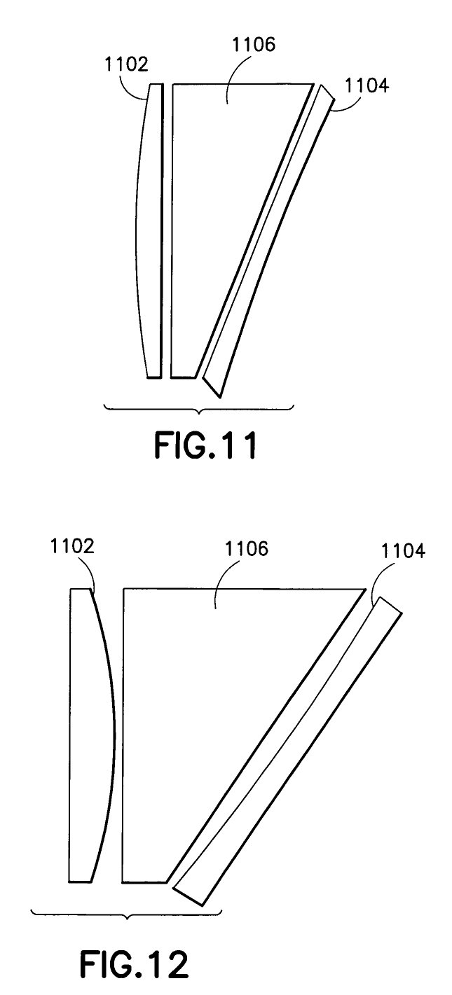

A relay prism can also be formed by using several components instead of one integrated component, although one component normally gives the highest efficiency. Examples of these different configurations are shown in FIGS. 11 and 12 which show relay prisms where the input surface (1102) and the output surface (1104) are implemented by separate optical components around a solid prism (1106) consisting of planar surfaces next to these separate components 1102, 1104. These separated optical components can also be integrated into some other optical components before/after the relay prism.

The relay prism can also contain other support or aligning structures as known in the art of optomechanical design which are not shown specifically in the schematic figures above. Although the figures above show embodiments of the relay prism where its cross section perpendicular to the optical axis is circular, that cross section could as well have another geometrical shape such as elliptical or rectangular. Typically the shape of that cross section is chosen so that the clear aperture of the component allows the whole beam to pass the component. Preferably the input and/or output surfaces of the relay prism are antireflection coated for maximized optical transmission. The relay prism can be made from optical plastic or glass materials for example, by tooling or preferably by moulding.

A liquid crystal display LCD was used as an exemplary micro-display in the examples above. The relay prism according to these teachings may equally be used with liquid crystal on silicon LCoS, digital micromirror device DMD, or some other micro-display and their corresponding optical engine configurations.

1. A data projector comprising:
at least one micro-display;
at least one light source chip; and
at least one optically transparent relay prism disposed between the micro-display and the light source chip, where the relay prism comprises an input surface and an output surface arranged to impose a tilt to a system optical axis between the micro-display and the light source.

2. The data projector of claim 1, wherein the tilt operates to change a first aspect ratio of a beam at the input surface to a second aspect ratio at the micro-display.

3. The data projector of claim 2, wherein at least one of the input and output surfaces comprises a cylindrical surface having parallel cross sections, each such cross section defining a center of curvature such that the centers of curvatures together define a line that crosses the system optical axis or an extension of the system optical axis.

4. The data projector of claim 2, wherein the input surface is convex or concave.

5. The data projector of claim 2, wherein the input surface is aspheric.

6. The data projector of claim 2, wherein the input surface is biconic.

7. The data projector of claim 2, wherein the input surface is convex or concave.

8. The data projector of claim 2, wherein the output surface is aspheric.

9. The data projector of claim 2, wherein the at least one light source chip has a substantially square emitting area that measures 0.8 inches or less along its diagonal;
and the at least one microdisplay comprises a substantially rectangular display surface that is not square.

10. The data projector of claim 1, further comprising at least one collection and beam shaping optical device between the at least one light source chip and the relay prism, which collection and beam shaping optical device collects light from the light source chip and forms an angular substantially rectangular output beam with an aspect ratio different from an aspect ratio of an active surface of the rectangular micro-display.

11. The data projector of claim 10, further comprising at least one projection lens disposed such that the microdisplay lies optically between the projection lens and the relay prism.

12. The data projector of claim 1 wherein the relay prism functions to elongate illumination from the light source chip only in the direction of the tilt.

13. The data projector of claim 1, wherein the light source is substantially imaged to the microdisplay, and wherein the relay prism operates to change the magnification of the imaging differently in two different perpendicular directions across a face of the microdisplay.

14. An apparatus comprising:
illumination means;
display means;
lens means disposed between the display means and the illumination means, the lens means comprising a first surface and a second surface arranged for imposing a tilt to a system optical axis between the illumination means and the display means.

15. The apparatus of claim 14, wherein:
the illumination means comprises a light emitting diode chip having a first aspect ratio of 1:1;
the display means comprises a microdisplay having an active display surface with a second aspect ratio that is other than 1:1, and
the lens means comprises a relay prism and one of the first and second surfaces comprises a cylindrical optical surface that defines parallel cross sections, each of which define a center of curvature such that the centers of curvatures together define a line that crosses the system optical axis or an extension of the system optical axis.

16. The apparatus of claim 15, wherein the second aspect ratio is either 4:3 or 16:9.

17. The apparatus of claim 14, wherein the lens means operates to elongate illumination from the light emitting diode chip only in the direction of the tilt.

18. The apparatus of claim 14, wherein the illumination means is substantially imaged to the display means, and wherein the lens means operates to change the magnification of the imaging differently in two different perpendicular directions across a face of the display means.

19. A method for manipulating light comprising:
emanating light from a source to a relay prism along a first portion of a system optical axis;
passing the emanated light through the relay prism;
outputting the emanated light from the relay prism along a second portion of the system optical axis that is tilted with respect to the first portion; and
displaying the light output from the relay prism at a micro-display.

20. The method of claim 19, further comprising directing the light from the micro-display to a projection lens.

21. The method of claim 19, wherein the light is emanated from the source with a first aspect ratio and is displayed at the micro-display at a second aspect ratio, and the relay prism operates to change the light from the first aspect ratio to the second aspect ratio without clipping the emanated light.

22. The method of claim 21, wherein emanating light from the source further comprises collecting light from the source and shaping it, in a collection and beam shaping device disposed between the source and the relay prism, to an angular substantially rectangular output beam with the first aspect ratio.

23. The method of claim 19, wherein the rely prism comprises a cylindrical optical surface that defines parallel cross section, each defining a center of curvature and the centers of curvatures define a line that crosses the system optical axis or an extension of the system optical axis.

24. The method of claim 23, wherein each center of curvature is one of a center of a circle or a focus of an ellipse.

25. The method of claim 19, wherein the source, the relay prism, and the micro-display are disposed and arranged within a pocket sized device.
